(19) United States
(12) Patent Application Publication
(10) Pub. No.: US 2005/0237306 A1
(43) Pub. Date: Oct. 27, 2005

(54) Tactile feedback through a computer keyboard key

(76) Inventors: Udo Klein, Maximiliansau (DE); Matthias Harbusch, Bad Schoenborn (DE)

Correspondence Address: FISH & RICHARDSON, P.C., PO BOX 1022, MINNEAPOLIS, MN, 55440-1022, US

(21) Appl. No.: 10/832,581

(22) Filed: Apr. 27, 2004

(51) Int. Cl. G09G 5/00

(52) U.S. Cl. 345/168

(57) ABSTRACT

Tactile feedback may be provided to a user of a computer device through a key on a computer keyboard. A method may comprise detecting a predetermined event in a computer device, and making a predetermined electronic output from the computer device to a keyboard connected to the computer device, the predetermined electronic output providing a tactile feedback to a user through a key on the keyboard. An electromagnetic device such as a linear actuator may provide the tactile feedback. A motion sensor may register key movement and produce an output that the computer device interprets as depression of the key.

### TECHNICAL FIELD

This description relates to providing tactile feedback to a user through a key on a computer keyboard.

### BACKGROUND

Almost all of today's computer systems or devices include at least one keyboard by which a user can input information. For example, IBM-compatible personal computers may have a special connector, or port, called a PS/2 connector, to which many keyboards available on the market today can be connected. Keyboards that are capable of using the interface required by such computers and ports are sometimes referred to as PS/2 keyboards.

Also, most computer systems provide feedback to a user. That is, when there is a need for the system to alert the user of a certain condition or to confirm that an operation has been performed, these systems can output some form of signal to the user. One common type of feedback is a visual feedback displayed on a display device connected to a computer. A visual feedback may be verbal, such as a written message, or non-verbal, such as an icon or other symbol that appears, or a color change in some feature of the graphical user interface (GUI). Off-screen feedback includes switching a “Caps Lock” light on or off, for example. Many systems also provide audio feedback, for example through a speaker located inside the computer device or through a speaker external to the computer device.

There are disadvantages, however, with these types of feedback. Not every user looks at the screen when typing on a keyboard, and may therefore miss important visual clues. In those systems where the visual message blocks further input from the keyboard until the user clicks on (or otherwise acknowledges) the visual message, a user who is not watching the screen may inadvertently continue typing while being unaware of the message. In such a situation, important user input may be lost. Audio feedback, in turn, can be irritating to users, especially when the sound is an error signal. Moreover, computer-generated sounds may induce uncomfortable noise in an environment where more than one person is working. When several people are using nearby computers, such as across a desk from each other, it can sometimes be difficult for them to determine whose computer generated the sound. Also, audio feedback may not be useful for persons who do not hear well.

### SUMMARY

The invention relates to providing tactile feedback through a computer keyboard key. In a first general aspect, a method comprises detecting a predetermined event in a computer device, and making, upon the predetermined event, a predetermined electronic output from the computer device to a keyboard connected to the computer device. The predetermined electronic output providing a tactile feedback to a user through a key on the keyboard.

In selected embodiments, the predetermined event is one selected from the group consisting of: an error in the computer device, the user typing a maximum number of characters in an input field, the user attempting to type more characters than allowed in an input field, the user typing an improper type of character in the input field, the user depressing the key on the keyboard, and combinations thereof.

In selected embodiments, the tactile feedback comprises an action selected from the group consisting of: bumping the key, shaking the key, vibrating the key, and combinations thereof.

In selected embodiments, the tactile feedback comprises controlling a resistance against the user depressing the key.

In a second general aspect, a computer keyboard comprises a housing having a plurality of keys with which a user can make an input when the computer keyboard is connected to a computer device, and a device connected to at least one of the plurality of keys for providing a tactile feedback to the user through the at least one key upon a predetermined electronic output from the computer device to the computer keyboard.

In selected embodiments, the predetermined electronic output is provided in a cable for input from the keyboard to the computer device. In selected embodiments, the predetermined electronic output is provided in a separate cable from a cable for input from the keyboard to the computer device.

In selected embodiments, the predetermined electronic output may be caused by an application incorporated in, or separate from, a computer keyboard driver application that manages keyboard input to the computer device.

Advantages of systems and techniques described herein may include any or all of the following. Providing tactile feedback through a key on a computer keyboard. Selectively controlling a resistance against depressing a computer key. Improved user feedback from a computer system. Providing computer feedback that is perceived essentially only by one user. Providing feedback through a computer keyboard that is not perceived with vision or hearing. Providing a user feedback that can be perceived without the user looking at a screen. Providing a user feedback that does not generate disturbing noise through a speaker. Providing tactile feedback without modifying a driver application for the computer keyboard.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of a system including an embodiment of an inventive computer keyboard;

FIGS. 2A-E are exemplary embodiments of a key that can be implemented in the system shown in FIG. 1;

FIG. 3 is a block diagram including an embodiment of an inventive computer keyboard;

FIG. 4 is a flow chart of an embodiment of an inventive method; and

FIG. 5 is a block diagram of a general computer system.

Like reference numerals in the various drawings indicate like elements.

### DETAILED DESCRIPTION

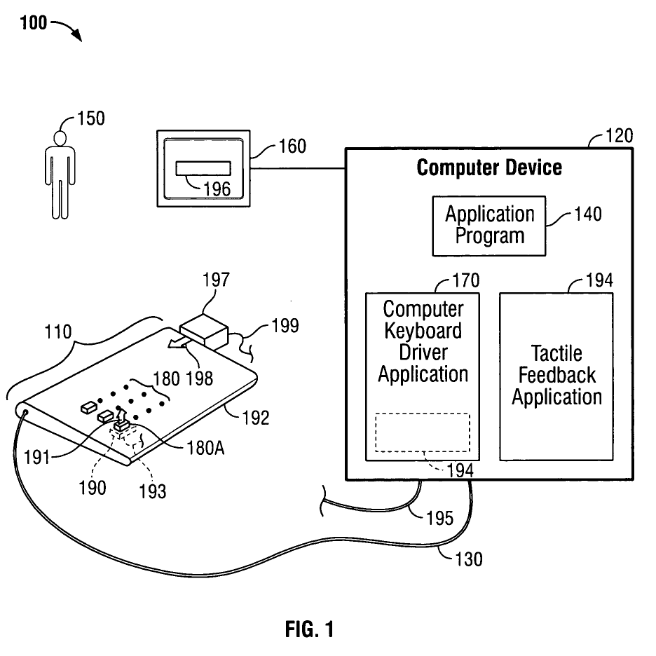

FIG. 1 schematically illustrates a system 100 that can provide tactile feedback through a computer keyboard key. The system includes a computer keyboard 110 connected to a computer device 120 through a cable 130. The computer device includes at least one application program 140 that a user 150 can cause to operate in the system, as is well known. The application program may cause the system to generate a GUI on a display device 160 connected to the computer device. User input from the computer keyboard 110 to the computer device may be managed by a computer keyboard driver application (CKDA) 170 as is well known. Essentially, the CKDA may provide an interface between the computer keyboard 110 and the computer device. For example, when the user depresses one or more of keys 180 on the computer keyboard 110, the CKDA may provide that corresponding signals generated by the computer keyboard are received and understood by the computer device.

The computer keyboard 110 may comprise a device 190 inside a housing 192. The device 190 is currently shown in phantom, located underneath one key 180A. The device 190 provides tactile feedback to the user through one of the keys 180, for example such that the user senses a vibration or bump in his or her fingertip. In FIG. 1 the tactile feedback is conceptually indicated by arrow 191. Examples of specific locations for the device 190 will be described below. In some implementations, a similar device 190 may be provided for each of several or all of the keys 180, for selectively providing tactile feedback through any such key.

The tactile feedback 191 may include bumping the key, shaking the key, vibrating the key, and combinations thereof. The device 190 may comprise anything that is capable of providing tactile feedback through the key, such as an electromagnetic device. The device 190 may comprise one or more of a motor, an oscillator, a linear actuator, an agitator or combinations thereof, for example a vibrating device of the type commonly used in cellular telephones, or in joysticks or other video game controls. Depending on its energy consumption, the device 190 may be powered from the same power source that is used for inputting information from the computer keyboard; in general, the computer device. In other implementations, the device 190 may be connected to a separate power source.

The device 190 may provide tactile feedback upon a predetermined electronic output being generated from the computer device. The device 190 may receive the output through any suitable connection, for example a cable 193. A tactile feedback application (TFA) 194 may contain at least one executable instruction that causes the computer device to make the predetermined electronic output upon occurrence of a predetermined event, as will be described.

In some implementations, the output is made through the same cable 130 that manages input from the computer keyboard to the computer device. There may therefore be a connection between the cable 130 and the cable 193. For example, such a connection may be established by connecting the cable 193 to a processor located inside the computer keyboard. Such a processor is connected to the cable 130 to manage the signals sent from the keyboard to the computer device and other functions such as the illumination of a “Caps Lock” indicator light (not shown) on the keyboard, as is well known. By including suitable logic in such a processor, it can be configured to recognize the predetermined electronic output made by the computer device and, in response thereto, activate the device 190 to provide tactile feedback. It may be necessary to modify the communications protocol that is used between the keyboard processor and the computer device to ensure that the predetermined electronic output can be sent at appropriate times, for example immediately upon one or more predetermined events in the computer device. In these kinds of implementations, the TFA 194 may be incorporated in the CKDA 170, as shown in phantom.

Some same-cable implementations may use the Universal Serial Bus (USB) standard. Assume, for example, that the keyboard connects to the computer device through a USB cable. The USB standard supports connecting many devices to the same port. The USB connection can therefore be divided—preferably at the keyboard end so that the user only needs to insert one plug into the computer—and both the keyboard and one or more of the device 190 can be controlled through the USB connection. That is, the USB that is originally intended only for the keyboard can be used both for the keyboard and for the device 190. In some same-cable USB-implementations, the keyboard and the device 190 are identified to the computer device as separate devices. That is, the device 190 can operate independently of the keyboard, which need not be “aware” of it. There may accordingly be no reason to modify a keyboard driver. In other implementations, the two are identified as a single device to the computer device. That is, the keyboard driver in the computer device may be configured such that the operation of the device(s) 190 is integrated in the driver's handling of the keyboard.

In other implementations, the output from the computer device to the device 190 may be made in a separate cable 195. The cable 193 may therefore be connected to the cable 195. The cable 195 may use any suitable connector or port on the computer device, such as a PS/2 port, serial port, parallel port or any kind of USB port. The TFA should be configured such that the proper predetermined electronic output is generated in the port to which the cable 195 is connected. One advantage of such implementations is that tactile feedback may be implemented without using the ordinary keyboard cable and without modifying the keyboard processor. In such implementations, there may also be no need to modify the CKDA 170, which may accordingly be “unaware” that any feedback is being provided.

It will now be described some examples of when tactile feedback 191 may be generated. For example, assume that the user makes an input by depressing the key 180A and that this causes an error in the computer device. For example, the input creates an exception or an undefined condition in the application program 140. This is an example of a predetermined event that may warrant tactile feedback to inform the user about the error. Accordingly, the TFA 194 may provide that the computer device makes the predetermined electronic output upon the predetermined event. Upon receiving the predetermined electronic output, the device 190 may provide tactile feedback to the user through the key 180A.

As another example, assume that the user is typing characters into an input field 196 in the GUI of the application program 140. The field 196 in this example is limited to inputting a maximum number of characters. The application program 140 may therefore block the field from further input after the user enters the maximum number of characters. Here, the user is not aware of this restriction, however, and attempts to type more than the allowed number of characters in the field. The user's continued typing, on the key 180A in this example, causes a signal to be transmitted from the keyboard to the computer device. Receipt of this signal may trigger a predetermined event in the computer system that in turn causes tactile feedback to be generated. As another example, the predetermined event may be triggered when the user types the maximum number of characters that the field permits. That is, when the user types the last character, the predetermined event can cause tactile feedback, such as by bumping the key, to alert the user that he or she has reached the end of the field. The duration of the tactile feedback may vary. For example, a relatively brief vibration of the key—such as for only a fraction of a second—may indicate a condition that is not considered particularly serious. A longer feedback, in contrast, may indicate a problem that perhaps requires user intervention. In some implementations, the device 190 may provide tactile feedback with every keystroke, even in the absence of errors or input blocking in the computer device.

As yet another example, assume that the field 196 is limited to inputting numbers, as opposed to letters or other characters. The application program 140 may therefore block the field from any keyboard input that comprises a non-numerical character. Here, the user is not aware of this restriction, and attempts to type one or more letters in the field. The signal(s) from the keyboard upon the user's typing may trigger a predetermined event in the computer system that subsequently causes tactile feedback to be generated.

The above are merely a few examples of predetermined events that can cause tactile feedback to be generated, and other events may be used in some implementations. Moreover, it may be possible to generate tactile feedback of different intensities. For example, the device 190 may be able to recognize different predetermined electronic outputs that correspond to more or less tactile feedback. That is, for a specific predetermined event the system 100 may select a particular output among multiple predetermined electronic outputs to provide a tactile feedback of desired intensity. For example, a high-intensity feedback may be used for error events, a medium-level feedback for less serious conditions, and a low-level feedback for every keystroke. The “every keystroke” feedback may be provided upon the user continuously depressing the key, which typically triggers an “auto repeat” entry of multiple characters. Also, the system 100 may provide a convenient way for the person 150 to switch the tactile feedback function on or off; for example, through an input control in the displayed GUI, akin to a “mute” button for a speaker volume.

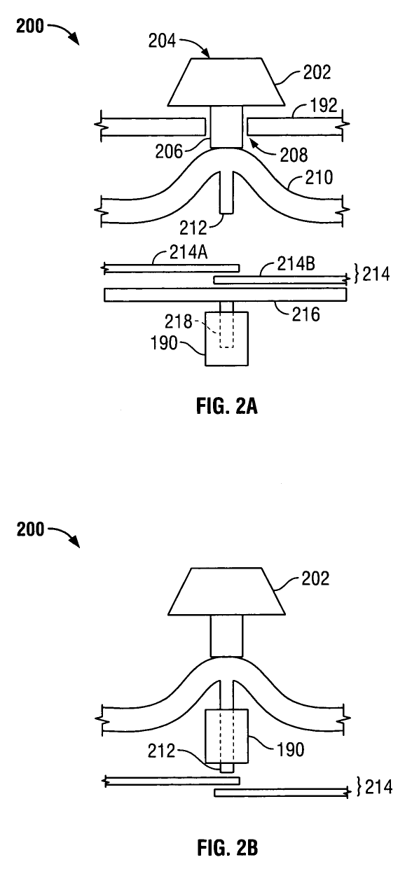

FIGS. 2A-D are examples of how tactile feedback through a keyboard key can be implemented. In each of the figures, an embodiment of a computer keyboard key 200 is shown from the side in exploded view. The key 200 includes a head 202 which is the portion that is typically visible to a user and which can be used to depress the key. The head may have a keycap 204 indicating the character or function that the key corresponds to. The key head 202 sits on top of a key member 206 that passes through an opening 208 in the keyboard housing 192. In the following figures, the housing 192 is omitted for clarity.

The key member 206 abuts a dome 210. The dome 210 is a well-known component of existing computer keyboards that provides a desirable “feel” for the user when depressing the key. The dome 210 therefore is typically made of a resilient or flexible material, such as rubber. Often, the dome 210 is part of a mat made of the same material that lies underneath the entire set of keys 180 in a keyboard and each key has its own dome in the mat.

When the key head 202 is depressed, the dome 210 is deformed due to the applied pressure. This causes a plunger 212 inside the dome 210 to move, essentially in the direction that the key is being pushed (e.g., downward). Located below the plunger is a switch 214 by which input(s) from the keyboard to the computer can be made. Any kind of computer keyboard switch can be used, and the depiction of blade contacts 214A and 214B in the switch 214 is merely a conceptual representation of the entire class of switches.

In some implementations, the key 200 is normally open and causes an input to be made from the keyboard when the switch 214 closes. This is schematically illustrated by the switch contacts 214A and 214B being spaced apart in the figure. In other implementations, such as when the switch 214 is a capacitive switch, the switch 214 is normally closed but can be opened by depressing the key. In both normally-open and normally-closed implementations, the plunger movement causes the keyboard to make an input to the computer device, the input corresponding to the depressed key.

The switch 214 is situated on a base 216. Underneath the base 216, a member 218 extends at least partially into the device 190. For example, the device 190 may here be a linear actuator sold under the model number NCC01-04-001-1X and available from H2W Technologies, Inc. in Valencia, Calif. When the key head 202 is depressed, and the key member 206 is pressing the dome 210 against the switch 214, the applied force will tend to move the member 218 further into (or through) the linear actuator 190. By its electromagnetic capabilities, the linear actuator can resist the member 218 being driven further through it, or can apply a force that tends to push the member 218 in the opposite direction that the key is being depressed. Applying any of these forces in a periodic or otherwise non-constant manner may provide a rhythmic sensation to the user through the key head 202. Accordingly, the linear actuator can provide a vibrating, shaking or bumping motion to the user while the user is depressing the key head.

FIG. 2B shows another embodiment of the computer key 200. Mainly, the device 190 is here located above the switch 214. The plunger 212 passes through the device 190 and may abut the switch 214. The plunger 212 may be formed of a material that is compatible with the operation of the device 190, such as a metal for an electromagnetic linear actuator. Similar to the description above, the device 190 may here provide a vibrating, shaking or bumping sensation through the key head 202.

As another example, the device 190 may here provide tactile feedback by controlling the resistance against the user depressing the key head 202. That is, while the previous descriptions of exemplary tactile feedbacks have focused on one or more discrete bursts of feedback (such as in bumping or vibrating the key), this implementation also is capable of varying the difficulty in depressing the key. That is, the device 190 may be actuated so as to increase the resistance for the plunger 212 passing through it. The increase in the resistance may be varied from a non-perceptible amount to a maximum resistive force that the device 190 can generate. In some implementations where the device 190 is sufficiently powerful and where adequate electric power can be supplied to it, the key 200 can be locked against depression.

A selective-resistance implementation may be useful for alerting the user of an important decision that can be made using the key. For example, the computer device may in some situations display a message box that says: “Are you sure you want to permanently delete this file?” or equivalent, wherein pressing the “Y” key (for “yes”) will cause the action to be performed. In such a situation, the tactile feedback may make the “Y” key perceptibly harder to depress, alerting the user to the important decision.

FIGS. 2C and 2D are other embodiments of the key 200 that include a motion sensor 220. A portion of the plunger 212 may pass through the motion sensor 220 similarly to how it passes through the device 190. For example, when the device 190 is a linear actuator, the shaft of the linear actuator may at least in part pass through the motion sensor 220. The motion sensor 220 senses the travel of the plunger 212, and hence that of the key head 202.

The sensor 220 may be connected so that the computer device receives its output signal. The computer device therefore can be configured to detect the depression of the key from the motion sensor output. In such implementations, the conventional key switches may be omitted from the keys, and the CKDA 170 may include executable instructions specifying how the computer device interprets the motion sensor output. For example, a certain amount of downward travel of the plunger 212 may be deemed a depression of the key. In contrast, the computer device may treat a lesser amount of downward movement as not being a depression of the key, such as if the user is merely resting a finger on the key head 202 without actively depressing it. Small key movements may, however, be used to trigger a specific response from the computer device, as described in the following.

A small downward travel of the key head 202 (and the plunger 212) may indicate that the user is about to depress the key. In response, the computer device may provide tactile feedback in that key, as opposed to in another key that is not currently being depressed. The tactile feedback may involve providing a bump, vibration or shaking of the key, or may involve controlling the resistance against further depressing the key. For example, upon the user beginning to depress a key that corresponds to an important decision, the computer device can provide tactile feedback that alerts the user to this fact. As another example, the computer device may lock the key against further depression, perhaps because the key corresponds to a character that currently cannot be input into the computer device. One advantage of these implementations is that electrical current in the keyboard and the processor resources are used only for the key that the user is actually depressing, not for every (applicable) key as a precaution.

The dome 210 may be omitted in some implementations, for example as shown in FIG. 2D. That is, when the user depresses a dome-less key, the device 190 can provide tactile feedback that resembles the feel typically provided by a rubber dome or equivalent. In such implementations, the key member 206 may at least in part pass through the device 190 and the motion sensor 220. Accordingly, the key member 206 may be made of a suitable material, such as a metal that is used for shafts in linear actuators. While the device 190 is here situated “above” the motion sensor 220, its position may be different in some implementations, such as below the motion sensor.

FIG. 2E shows another embodiment of the key 200. Here, a shaft 222 of the device 190 abuts the switch contact 214A. Hence, when the key head 202 is depressed and the plunger 212 moves the contact 214A toward contact 214B, the device 190 can provide tactile feedback through the shaft 222, for example by vibrating the contact 214A or by controlling the resistance against bringing the two contacts together. In some implementations, the shaft 222 may freely pass through an opening 224 in the contact 214B. In other implementations, the shaft may abut a part of the contact 214A that extends beyond the contact 214B.

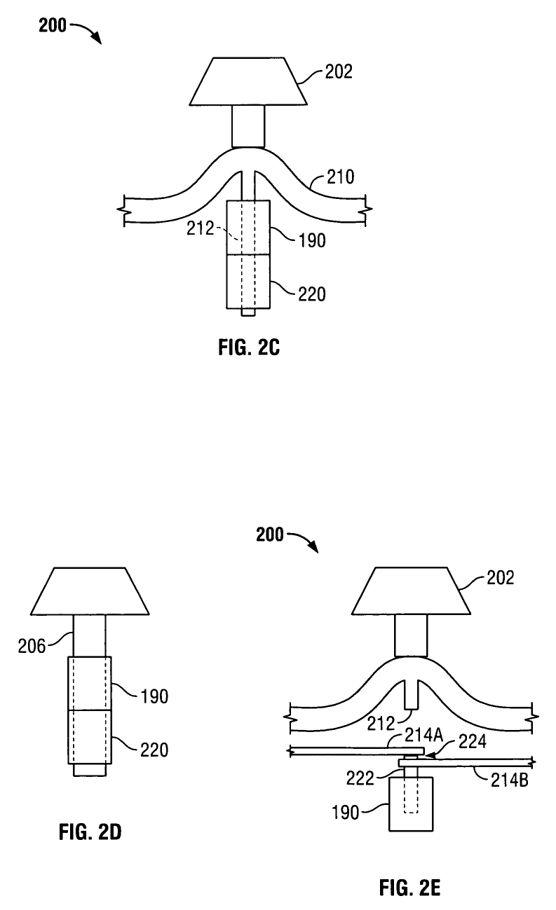

FIG. 3 is a block diagram of a system 300 that can be used for providing tactile feedback through one or more computer keyboard keys. For example, the system 300 may be included in the system 100 shown in FIG. 1. The keyboard 110 is connected to the computer device 120 through an input/output (I/O) module 310. This allows the keyboard to receive the predetermined electronic output from the computer device. The I/O module 310 is connected to a bus 320 in the keyboard. The keyboard further comprises a processor 330, a Random Access Memory (RAM) 340 and a code storage 350. Essentially, the processor 330 can execute code stored in the code storage 350 and, when necessary, information can be stored in the RAM 340. The components 310-350 may for example be those included in a conventional computer keyboard.

One or more electromechanical devices 360 are capable of providing tactile feedback through one or more keys of the keyboard 110. The device 360 is connected to the bus 320 through connector 365. Upon the computer device sending the predetermined electronic output to the keyboard, the keyboard processor 330 can initiate the device 360 to provide tactile feedback. For example, the device 360 may be a vibrating device. Besides hardware for providing the tactile feedback, the device 360 may include a suitable driver, amplifier, or other such device, that appropriately strengthens the signal from the keyboard processor.

In implementations where it should be possible to provide tactile feedback through several, or all, of the keys 180, each of those keys may be connected to a separate, essentially equivalent, device 360. That is, the keyboard may be provided with a plurality of electromechanical devices, one underneath each key. When the processor 330 does not have a sufficient number of outputs for individually addressing the several electromechanical devices, a demultiplexer 370 may be connected to the processor by connector 375. The demultiplexer 370 receives the signal that is intended for a specific one of the electromechanical devices, identifies the correct device, and sends a signal to that device using one of several output lines 380 leading to the respective devices.

In certain embodiments, parameters relating to use of the key can be altered. Examples of key parameters include: a key preload, a key peak force, a key travel, a key drop force, a key activation point, a key overtravel, and combinations thereof. The purpose of altering any or all of the key parameters may be to better configure the keyboard for the particular user, to reduce inadvertent key depressions, to name just a few examples. The computer device 120 can monitor the characteristics of how a particular user depresses one or more of the keys and make appropriate adjustments in any or all of the parameters.

Referring again to FIG. 1, the keyboard 110 in some implementations is provided with a second device 197 that also is capable of providing tactile feedback. The device 197 provides feedback through the keyboard 110 and is not associated with any particular one of the keys 180, each of which may have a separate tactile-feedback device. The device 197 may receive a predetermined electronic output from the computer device upon a predetermined event, such as an error or an input blocking as described above. The tactile feedback provided by the device 197 is schematically illustrated by an arrow 198.

The tactile feedback 198 may complement or substitute the tactile feedback 191 that can be provided by the key-specific device(s) 190. For example, the feedback 198 may be used for general errors or alerts while the feedback 191 may be used for situations that involve a specific key. As another example, when fewer than all of the keys 180 are provided with individual devices 190, the feedback 198 may be used as a feedback applying to any key that does not have individual feedback.

The device 197 may be located nearby or abutting the housing 192. For example, the device 197 may be placed on top of, underneath, on a side of or inside the keyboard 110, or in any combination of these locations. The device 197 may receive the predetermined electronic output from the computer device through a cable 199. Similarly to the description above, the cable 199 may be connected to the cable 130 through the keyboard processor. Alternatively, there may be a separate cable from the computer device, analogous to the cable 195.

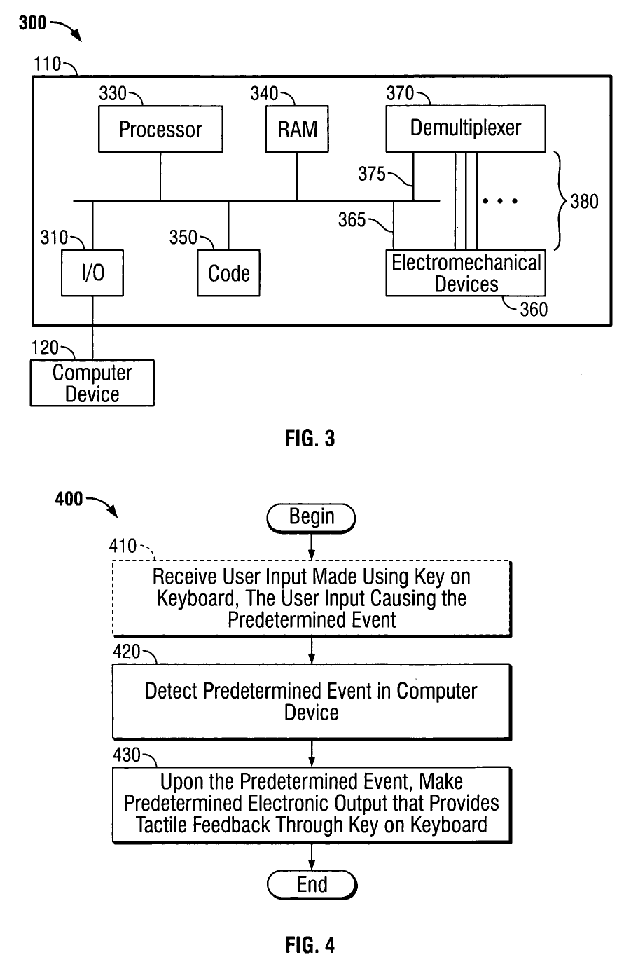

FIG. 4 shows a flow chart of a method 400 according to an embodiment of the invention. Preferably, the method 400 is performed in the system 100. For example, a computer program product can include instructions that cause a processor to perform the steps of the method 400. Method 400 includes the following steps:

Receiving, in optional step 410, a user input in the computer device made using a key on the keyboard. The optional input may cause the predetermined event to occur in the computer device. For example, the system 100 can receive an input that the user 150 makes by depressing one of the keys 180 on the computer keyboard 110. The optional input may comprise the small key travel at the onset of a key depression.

Detecting, in step 420, a predetermined event in the computer device. For example, the predetermined even may be an error or may be the state wherein the system receives user input for an input field that is blocked from receiving the input. Other examples of the event include registering that the user is depressing the key; that is, the system may provide tactile feedback for each depression.

Making, in step 430 and upon the predetermined event, a predetermined electronic output from the computer device. The predetermined electronic output provides a tactile feedback to the user through a key on the keyboard. For example, the tactile feedback may comprise a bump, vibration or shaking of the key, or may comprise controlling a resistance against depressing the key. In implementations where the optional user input is received in optional step 410, the tactile feedback may be provided in the key with which the input is made. For example, the predetermined electronic output may be made through cable 130 or through cable 195.

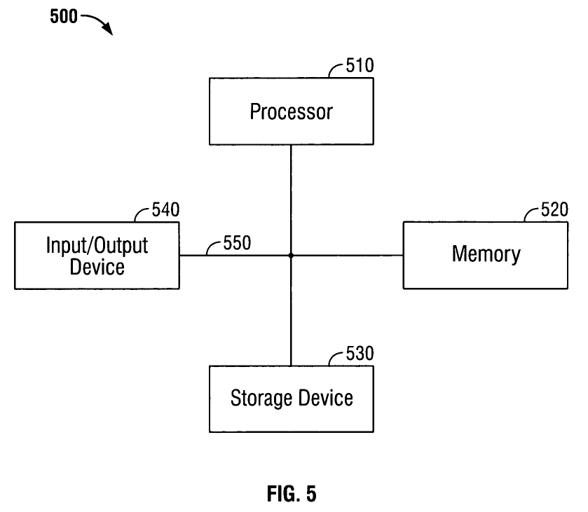

FIG. 5 is a block diagram of a computer system 500 that can be used in the operations described above, according to one embodiment. The system 500 includes a processor 510, a memory 520, a storage device 530 and an input/output device 540. Each of the components 510, 520, 530 and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 may include a computer keyboard as discussed above.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, any of the described cable connections may be a wireless connection. Accordingly, other embodiments are within the scope of the following claims.

1. A method of providing tactile feedback to a user of a computer device, the method comprising:
detecting a predetermined event in a computer device; and
upon the predetermined event, making a predetermined electronic output from the computer device to a keyboard connected to the computer device, the predetermined electronic output providing a tactile feedback to a user through a key on the keyboard.

2. The method of claim 1, further comprising selecting the predetermined electronic output to provide a specific intensity to the tactile feedback.

3. The method of claim 1, wherein the predetermined event is one selected from the group consisting of: an error in the computer device, the user typing a maximum number of characters in an input field, the user attempting to type more characters than allowed in an input field, the user typing an improper type of character in the input field, the user depressing the key on the keyboard, and combinations thereof.

4. The method of claim 1, wherein the predetermined electronic output is provided in a cable for input from the keyboard to the computer device.

5. The method of claim 1, wherein the predetermined electronic output is provided in a separate cable from a cable for input from the keyboard to the computer device.

6. The method of claim 1, wherein the predetermined electronic output is made according to an executable instruction included in a computer keyboard driver application in the computer device, the computer keyboard driver application managing input from the keyboard to the computer device.

7. The method of claim 1, wherein the predetermined electronic output is made according to an executable instruction included in an application other than a computer keyboard driver application that manages input from the keyboard to the computer device.

8. The method of claim 1, wherein the tactile feedback comprises an action selected from the group consisting of: bumping the key, shaking the key, vibrating the key, and combinations thereof.

9. The method of claim 1, wherein the tactile feedback comprises controlling a resistance against the user depressing the key.

10. The method of claim 9, wherein the predetermined event is associated with an important decision that the user can make by depressing the key.

11. The method of claim 9, wherein the resistance is controlled so as to lock the key against being depressed.

12. The method of claim 11, wherein the predetermined event comprises that a character to which the key corresponds cannot be input into the computer device.

13. The method of claim 1, further comprising receiving a user input in the computer device from the keyboard, the user input causing the predetermined event.

14. The method of claim 13, wherein the user input is an auto repeat input.

15. The method of claim 1, further comprising altering a key parameter together with providing the tactile feedback.

16. The method of claim 15, wherein the key parameter is one selected from the group consisting of: a key preload, a key peak force, a key travel, a key drop force, a key activation point, a key overtravel, and combinations thereof.

17. The method of claim 15, wherein the key parameter is altered upon monitoring use of the key over time.

18. A computer keyboard comprising:
a housing having a plurality of keys with which a user can make an input when the computer keyboard is connected to a computer device; and
a device connected to at least one of the plurality of keys for providing a tactile feedback to the user through the at least one key upon a predetermined electronic output from the computer device to the computer keyboard.

19. The computer keyboard of claim 18, wherein the device is one selected from the group consisting of: an electromagnetic actuator, a piezoelectric actuator, and combinations thereof.

20. The computer keyboard of claim 18, wherein a movable part associated with depressing the key passes through the device at least partly.

21. The computer keyboard of claim 18, wherein the device is located above a switch by which an input is made to the computer device when the key is depressed.

22. The computer keyboard of claim 21, wherein the device is connected to a plunger capable of actuating the switch.

23. The computer keyboard of claim 18, wherein the device is located below a switch by which an input is made to the computer device when the key is depressed.

24. The computer keyboard of claim 23, wherein. the switch comprises a first contact that is moved toward a second contact upon depressing the key, and wherein the device abuts the first contact.

25. The computer keyboard of claim 18, wherein the device performs an action selected from the group consisting of: bumping the key, shaking the key, vibrating the key, and combinations thereof.

26. The computer keyboard of claim 18, wherein the device controls a resistance against the user depressing the key.

27. The computer keyboard of claim 18, further comprising a plurality of devices for providing the tactile feedback, each of the devices being connected to one of the plurality of keys.

28. The computer keyboard of claim 18, further comprising a second device adjacent the housing for providing a second tactile feedback to the user through the keyboard.

29. The computer keyboard of claim 18, wherein the predetermined electronic output is provided in a cable for input from the keyboard to the computer device.

30. The computer keyboard of claim 18, wherein the predetermined electronic output is provided in a separate cable from a cable for input from the keyboard to the computer device.

31. The computer keyboard of claim 18, wherein the predetermined electronic output is made according to an executable instruction included in a computer keyboard driver application in the computer device, the computer keyboard driver application managing input from the computer keyboard to the computer device.

32. The computer keyboard of claim 18, wherein the predetermined electronic output is made according to an executable instruction included in an application other than a computer keyboard driver application that manages input from the computer keyboard to the computer device.

33. The computer keyboard of claim 18, further comprising a motion sensor that senses when the key is being depressed, wherein the input that the user can make involves using an output from the motion sensor and not a switch connected to the key.

34. The computer keyboard of claim 33, wherein the tactile feedback is provided in response to the input made by depressing the key.

35. A computer program product tangibly embodied in an information carrier, the computer program product including instructions that, when executed, cause a processor to perform operations comprising:
detect a predetermined event in a computer device; and
upon the predetermined event, make a predetermined electronic output from the computer device to a keyboard connected to the computer device, the predetermined electronic output providing a tactile feedback to a user through a key on the keyboard.

36. The computer program product of claim 35, separate from a computer keyboard driver application that manages keyboard input to the computer device.
